(19) United States
(12) Patent Application Publication
(10) Pub. No.: US 2015/0310533 A1
(43) Pub. Date: Oct. 29, 2015

(54) CONSIGNED INVENTORY PROCUREMENT SYSTEM

(71) Applicant: Oracle International Corporation, Redwood Shores, CA (US)

(72) Inventors: Rohit Lobo PRABHU, Santa Clara, CA (US); Suman GUHA, Fremont, CA (US)

(73) Assignee: Oracle International Corporation, Redwood Shores, CA (US)

(21) Appl. No.: 14/261,501

(22) Filed: Apr. 25, 2014

(51) Int. Cl. G06Q 30/06; G06Q 30/04; G06Q 10/08

(52) U.S. Cl. CPC G06Q 30/0633; G06Q 10/087; G06Q 30/04

(57) ABSTRACT

A system is provided that manages consigned inventory procurement. The system generates an agreement including consignment terms and purchasing terms. The system further generates a consignment order for consigned inventory items, where the consignment order references the agreement. The system further generates a receipt in response to receiving the consigned inventory items, where the receipt references the consignment order. The system further generates a consumption advice in response to a consumption of a consigned inventory item, where the consumption advice references the agreement and the receipt. The system further sends the consumption advice to a supplier. The system further generates an invoice for the consigned inventory item in response to receiving a supplier invoice from the supplier, where the invoice references the consumption advice. The system further generates a payment for the consigned inventory item in response to a receipt of the invoice, where the payment references the invoice.

### FIELD

One embodiment is directed to a computer system, and more particularly, to a computer system that facilitates procurement.

### BACKGROUND

“Consigned inventory” is an inventory of items or services that is in the possession of a buyer but still owned by a supplier. In other words, the supplier places some of their inventory in the buyer's possession (e.g., in the buyer's store or warehouse), and allows the buyer to consume directly from the supplier's inventory. The buyer purchases the inventory from the supplier only when the inventory is consumed. For example, Buyer A issues an order for 1,000 items of widget X. Supplier B receives the order and ships 1,000 items of widget X to Buyer A. Buyer A receives the 1,000 items of widget X and places the 1,000 items in consigned inventory. Although Buyer A takes physical possession of the 1,000 items of widget X, ownership of liability for the 1,000 items remains with Supplier B. Buyer A subsequently withdraws 10 items from the consigned inventory of 1,000 items of widget X. Buyer A pays Supplier B for the 10 items of widget X, and assumes ownership of liability for the 10 items.

A consigned inventory model is generally used in scenarios where the buyer would not stock certain items due to working capital constraints or demand uncertainty. In such scenarios, consigned inventory can allow the supplier to provide a higher service level (by having the items immediately available), save expedited freight costs, and ensure the buyer does not procure the items from a competitor. The buyer benefits by reducing its investment in inventory and improving its working capital balance.

### SUMMARY

One embodiment is a system that manages a consigned inventory procurement. The system generates a blanket purchase agreement including consignment terms and purchasing terms. The system further generates a consignment order for consigned inventory items, where the consignment order references the blanket purchase agreement. The system further generates a receipt in response to receiving the consigned inventory items, where the receipt references the consignment order. The system further generates a consumption advice in response to a consumption of a consigned inventory item, where the consumption advice references the blanket purchase agreement and the receipt. The system further sends the consumption advice to a supplier. The system further generates an invoice for the consigned inventory item in response to receiving a supplier invoice from the supplier, where the invoice references the consumption advice. The system further generates a payment for the consigned inventory item in response to a receipt of the invoice, where the payment references the invoice.

### BRIEF DESCRIPTION OF THE DRAWINGS

Further embodiments, details, advantages, and modifications will become apparent from the following detailed description of the preferred embodiments, which is to be taken in conjunction with the accompanying drawings.

FIG. 1 illustrates a block diagram of a system that can implement an embodiment of the invention.

FIG. 2 illustrates a consigned inventory procurement process, according to an embodiment of the invention.

FIG. 3 illustrates a consumption advice generation process, according to an embodiment of the invention.

FIG. 4 illustrates an example sequence of events associated with a consumption advice generation process, according to an embodiment of the invention.

FIG. 5 illustrates a flow diagram of the functionality of a consigned inventory procurement module, according to an embodiment of the invention.

FIG. 6 illustrates a flow diagram of the functionality of a consigned inventory procurement module, according to another embodiment of the invention.

### DETAILED DESCRIPTION

According to an embodiment, a consigned inventory procurement system is provided that can consolidate consignment terms and purchasing terms on a blanket purchase agreement. This can eliminate a need to maintain an entry that is separate from the blanket purchase agreement for the purpose of carrying the consignment terms. The consigned inventory procurement system can further provide tracking and reconciliation across a consigned inventory procurement process by having a consignment order reference a blanket purchase agreement for its consignment terms, purchasing terms, and pricing terms. The consigned inventory procurement system can further provide a consumption advice document that defines a reporting period and that includes consumption transactions from that reporting period. The consigned inventory procurement system can also provide a set of terms that govern a frequency and period of generating the consumption advice.

The procurement of consigned inventory is typically governed by an agreement (also identified as a “blanket agreement” or a “blanket purchase agreement”) between a buyer and a supplier, which defines purchasing terms, pricing terms, and consignment terms (i.e., terms related to managing a consignment relationship between the buyer and the supplier). An example of a consignment term is an aging period (i.e., a time duration that a buyer can maintain possession of an item before the buyer is required to assume ownership of the item and pay the supplier for the item).

When ready to purchase items under a consignment arrangement (for example, in response to a requisition request), a buyer typically issues a purchase order to the supplier for the items using a procurement system. The purchase order can carry a provisional price for the consigned items. When the items are received by the buyer, they can be held as consigned inventory, where the supplier still owns the items, even though the buyer has possession of the items. As previously described, unlike regular purchases where ownership of the purchased items transfers to the buyer when the items are shipped to (and received by) the buyer, for consigned inventory purchases, the ownership transfer happens a later point in time, typically when the buyer actually consumes the consigned inventory items. At this point in time, the actual price for the items consumed is determined using pricing information from the blanket purchase agreement. The buyer can then create a consumption advice using the procurement system to inform the supplier of the quantities of the consigned inventory items, prices of the consigned inventory items, and dates the consigned inventory items were consumed. The suppler can use the consumption advice to initiate financial settlement.

In previous procurement systems, in order to enable a consigned inventory procurement process, the following configuration steps are typically required. First, the procurement system typically requires that a user set up terms that control a consignment arrangement (i.e., consignment terms). Procurement organizations typically maintain a list of data that associates items and services they buy with the suppliers that supply them. This association data is generally stored in a global repository that contains relevant details about each ship-from/ship-to/item relationship. These details are commonly known as an Approved Suppler List entry (“ASL entry”). The ASL entry allows the specification of the following consignment terms: (a) an indication whether or not an item can be purchased from a supplier under a blanket purchase agreement; (b) an aging period which specifies a period for which an item can be consigned at a buyer's location before the item is considered to be purchased by the buyer; and (c) a billing cycle which specifies how often a supplier expects to be notified about an item consumed by the buyer. As is described below in greater detail, the consignment terms may need to be defined for each supplier item combination in the form of ASL entry attributes. This can be very maintenance-intensive.

Next, the procurement system generally requires that the user set up terms that apply to an order being issued (i.e., purchasing terms and pricing terms). Organizations negotiate purchasing terms, as well as pricing terms, for items and services with their supplier, and capture this information within a blanket purchase agreement. A blanket purchase agreement is a long-term agreement for a purchase of items and services from a supplier. Although a blanket purchase agreement typically includes terms, details of the items or services to be purchased from the supplier, and negotiated quantities of the items or services, the blanket purchase agreement does not typically include delivery dates or individual delivery quantities. These details are typically specified in subsequent purchase orders issued against the blanket purchase agreement. When issuing a purchase order, the procurement system typically obtains the terms for an item from the blanket purchase agreement.

With the above setups in place, the procurement system typically invokes a programmatic application programming interface (“API”) in response to receiving a requisition identifying a preferred supplier, where the requisition can be created from a planning system. The programmatic API generally causes the procurement system to perform the following functionality. The procurement system first obtains consignment terms from an ASL entry. More specifically, using a supplier and a site specified on the requisition, the procurement system will try to find an ASL entry for the supplier-item or supplier-item category combination. If an ASL entry is found, the procurement system determines from the ASL entry whether the item is purchased from the supplier under a blanket purchase agreement, and can apply consignment terms to the purchase as appropriate.

The procurement system subsequently looks for a blanket purchase agreement. More specifically, once the procurement system had determined the consignment terms, the procurement system next looks for a blanket purchase agreement in order to determine the purchasing terms. The procurement system can give first preference to a blanket purchase agreement listed on the ASL entry. Further, a customer can have previously set up organization-specific rules and may want to use a specific blanket purchase agreement for an inventory organization. If a blanket purchase agreement is not listed on the ASL entry, the procurement system can look for the most recent blanket purchase agreement with the supplier.

Once the blanket purchase agreement has been found, the procurement system proceeds to create a consignment order. A supplier can use the consignment order to ship items, which are then received by the buyer and held as consigned inventory. As, and when, consigned inventory is consumed by the buyer, the supplier can be informed of the consumption via a consumption advice document or object which lists a consumption quantity, a consumption date, and a price of the items on the consumption date so that the supplier can initiate financial settlement. The consumption advice can use the blanket purchase agreement for its terms and for determining the price of the items on the consumption date. The supplier can then use the consumption advice to initiate financial settlement with the buyer.

Previous procurement systems typically have the following problems. The purchase agreement negotiated between the buyer and the supplier typically does not carry the consignment terms that govern the consignment arrangement. Instead, these consignment terms are generally stored on the ASL entry. This can lead to the following problems. First, the supplier may not have visibility to the ASL entry and its consignment terms which can prevent the supplier from effectively executing to the agreed terms during fulfillment. Second, the consignment terms may not be part of the blanket purchase agreement negotiated and agreed with the supplier. This can make it difficult for the buyer to monitor the supplier's compliance to the terms, and also, if required, enforce the consignment terms in case of disputes.

Further, in previous procurement systems, although the consignment order issued uses the purchasing terms and pricing terms from the blanket purchase agreement, the consignment order typically does not reference the blanket purchase agreement. As a result, there is no contractual reference on the consignment order to monitor compliance to blanket purchase agreement terms. In regular procurement processes, the blanket purchase agreement is generally released at the point of purchase order creation, and clearly tracks item quantities ordered as compared with agreed-upon item quantity thresholds. However, in consigned inventory processes, the blanket purchase agreement is not released until the point of consumption advice creation, which can be substantially later than the point of consignment order creation. Thus, the blanket purchase agreement typically does not track how much has been ordered until the date where the consignment order is sent to the supplier. Therefore, it is possible to order beyond an item quantity threshold that has been agreed upon in the agreement with the supplier, since the programmatic controls on the agreement to limit quantities purchased to the agreed-upon item quantity threshold may not work. Manual effort is likely needed to reconcile how much has been ordered versus what has been agreed upon within the blanket purchase agreement to prevent such over-ordering scenarios.

Additionally, in regular procurement processes, the purchase order which carries pricing information is not only used for receiving the items, but generally also serves as a billing document and tracks the billed quantity. The supplier shipment, good receipt, and the invoice can all be traced back to the purchase order for reconciliation. Thus, reconciliation of received and billed quantities can easily be done on the purchase order, and the purchase order can be closed when the quantities are fully received and billed. However, in consigned inventory processes, the consignment order is generally only used to receive consigned inventory items. The consignment order cannot typically be used as a billing document because the price on the consignment order is provisional, and the actual billing price is determined by the price at the time the consigned inventory items are consumed. Thus, the consumption advice, which has the billing price at the date of consumption, generally serves as the billing document for the consigned inventory items. However, this results in a problem in that there is no link between the consumption advice and the consignment order, and there is no link between the invoice and the consignment order. So although it is possible to trace the receipt and supplier shipment back to the consignment order, it is typically not possible to trace the consumption advice and the invoice back to the consignment order. This can require manual reconciliation of received and billed quantity for the consignment order to determine whether the consignment order has been fulfilled, and whether the consignment order can be closed.

Another problem lies in the level of effort that can be required to setup and maintain ASL entries, which store the consignment terms required by the procurement system to enable the consigned inventory process to work. The setup for ASL entries and sourcing rules (i.e., rules that define which supplier is used for an item) can be expensive because they are typically defined per item or per category of the item. Most items are usually procured from a single supplier under a pre-negotiated blanket purchase agreement. In addition, in most scenarios, the consignment terms are the same for all items purchased from a supplier. For consigned inventory items, it can be an unnecessary overhead to maintain a separate ASL entry for specifying the consignment arrangement for each item-supplier combination.

The following example further illustrates the actual cost of the overhead. A customer has an agreement for industrial pump parts with 1,000 line items. In this scenario, in order to enable a consignment arrangement with a supplier, the customer is required to setup 1,000 ASL entries, one for each line item. At five minutes per ASL entry, the estimated effort to enable consigned inventory procurement is 5,000 minutes (approximately 83 hours). In addition to setting up 1,000 ASL entries, the customer will likely need to maintain these consignment terms on each ASL entry going forward at an additional cost.

Further, consumption transactions can be created by the procurement system when the consigned inventory is consumed. A batch process can summarize these consumption transactions onto a consumption advice and send the consumption advice to the supplier. The batch process can look for consumption transactions that have been created in the procurement system since the blanket purchase agreement was first opened for execution. The batch process can then select the consumption transactions that have not yet been communicated to the supplier, can summarize these consumption transactions on a consumption advice, and can send the consumption advice to the supplier. The consumption advice can be modeled based on the blanket release which reports the consumption quantities and the prices as of the consumption date from the blanket purchase agreement that it references.

From the supplier's perspective, it is ideal to receive consumption advices in predictable intervals (e.g., daily, weekly, or monthly). It is also ideal for the consumption advice to include predictable content, and to have the capability to revise consumption advice for a period when consumption transactions reported in that period require adjustments. However, previous procurement systems typically do not meet these requirements. Instead, the frequency at which consumption advices are sent to the supplier are dictated by how often the batch process is scheduled to run, rather than having any negotiated terms or conditions that dictate a desired consumption advice frequency. For example, if the batch process is scheduled to run three times a day, then the supplier will receive three consumption advices each day, which will likely increase the supplier's administrative overhead. Further, the batch process creates a new consumption advice for all unreported consumption transactions, irrespective of the period of consumption. This can cause reporting problems for backdated consumption transactions from previous periods for which a consumption advice has already been sent. Instead of amending a previously reported consumption advice, a new consumption advice is created, which can be confusing to the supplier who receives multiple consumption advices for the same period. This can increase difficulty for suppliers in reconciling receiving and billing activity in any given reporting period and can cause unnecessary delays in financial settlement.

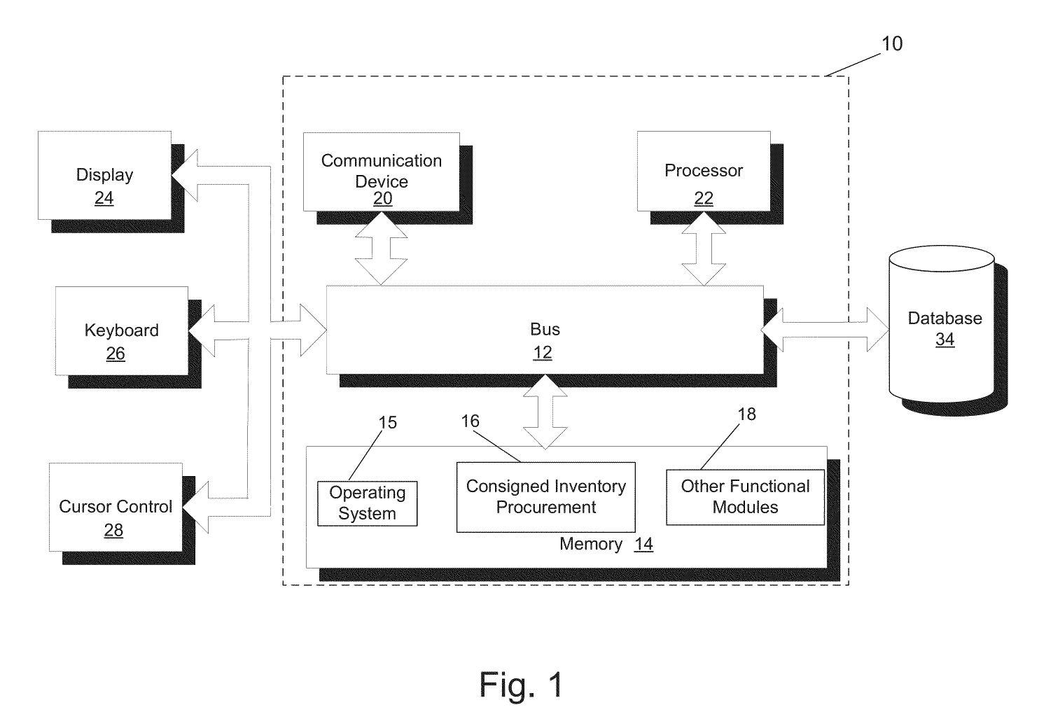

FIG. 1 illustrates a block diagram of a system 10, such as a consigned inventory procurement system, that can implement one embodiment of the invention. System 10 includes a bus 12 or other communications mechanism for communicating information between components of system 10. System 10 also includes a processor 22, operatively coupled to bus 12, for processing information and executing instructions or operations. Processor 22 may be any type of general or specific purpose processor. System 10 further includes a memory 14 for storing information and instructions to be executed by processor 22. Memory 14 can be comprised of any combination of random access memory (“RAM”), read only memory (“ROM”), static storage such as a magnetic or optical disk, or any other type of machine or computer-readable medium. System 10 further includes a communication device 20, such as a network interface card or other communications interface, to provide access to a network. As a result, a user may interface with system 10 directly, or remotely through a network or any other method.

A computer-readable medium may be any available medium that can be accessed by processor 22. A computer-readable medium may include both a volatile and nonvolatile medium, a removable and non-removable medium, a communication medium, and a storage medium. A communication medium may include computer readable instructions, data structures, program modules or other data in a modulated data signal such as a carrier wave or other transport mechanism, and may include any other form of information delivery medium known in the art. A storage medium may include RAM, flash memory, ROM, erasable programmable read-only memory (“EPROM”), electrically erasable programmable read-only memory (“EEPROM”), registers, hard disk, a removable disk, a compact disk read-only memory (“CD-ROM”), or any other form of storage medium known in the art.

Processor 22 can also be operatively coupled via bus 12 to a display 24, such as a Liquid Crystal Display (“LCD”). Display 24 can display information to the user. A keyboard 26 and a cursor control device 28, such as a computer mouse, can also be operatively coupled to bus 12 to enable the user to interface with system 10.

According to one embodiment, memory 14 can store software modules that may provide functionality when executed by processor 22. The modules can include an operating system 15, a consigned inventory procurement module 16, as well as other functional modules 18. Operating system 15 can provide an operating system functionality for system 10. Consigned inventory procurement module 16 can provide functionality for managing a consigned inventory procurement. In certain embodiments, consigned inventory procurement module 16 can comprise a plurality of modules, where each module provides specific individual functionality for managing a consigned inventory procurement. System 10 can also be part of a larger system. Thus, system 10 can include one or more additional functional modules 18 to include the additional functionality. For example, functional modules 18 may include modules that provide additional functionality, such as functionality of an “Oracle Fusion Procurement” product by Oracle Corporation.

Processor 22 can also be operatively coupled via bus 12 to a database 34. Database 34 can store data in an integrated collection of logically-related records or files. Database 34 can be an operational database, an analytical database, a data warehouse, a distributed database, an end-user database, an external database, a navigational database, an in-memory database, a document-oriented database, a real-time database, a relational database, an object-oriented database, or any other database known in the art.

According to an embodiment of the invention, as previously described, a consigned inventory procurement system can consolidate consignment terms from an ASL entry with purchasing terms on a blanket purchase agreement, so that both the consignment terms and the purchasing terms can be included within the blanket purchase agreement. Including the consignment terms required for consigned inventory procurement on the blanket purchase agreement can give trading partners the ability to negotiate and agree on consignment terms that both trading partners have visibility to. The blanket purchase agreement can be a single source of truth for the consignment terms that govern the entire consigned inventory procurement process. Further, according to the embodiment, including both the consignment terms and the purchasing terms within the blanket purchase agreement can eliminate the need to maintain a separate ASL entry for the purpose of establishing a consignment relationship between the trading partners and carrying the consignment terms.

According to the embodiment, by locating an active blanket purchase agreement that can be used to purchase an item for a requested organization, the consigned inventory procurement system would have enough information to determine whether the item is purchased under a consignment arrangement with the supplier. The information needed to enable the consignment arrangement can be determined as follows. First, the consigned inventory procurement system can select the supplier defined within the blanket purchase agreement as the supplier to whom the order is issued. Second, the consigned inventory procurement system can select the consignment terms defined within the blanket purchase agreement as the consignment terms used to determine whether the item is purchased under a consignment arrangement from the supplier. This can eliminate a need to setup and maintain consignment terms on separate ASL entries. Third, the consigned inventory procurement system can use the purchasing terms and the pricing terms defined within the blanket purchase agreement to create a consignment order. The consignment order can reference the blanket purchase agreement, and ultimately, can consume the blanket purchase agreement, enabling clear tracking of quantities of items that have been ordered up to a current date to prevent over-ordering (i.e., exceeding item quantity thresholds).

According to the embodiment, users of the consigned inventory procurement system will not be required to setup or maintain ASL entries and sourcing rules. The consigned inventory procurement system can offer a vastly reduced setup and maintenance cost for a consigned inventory procurement process. Further, for users with complex consigned inventory procurement processes (e.g., a procurement process that deals with specialized raw materials with multiple sources), ASL entries can still be utilized, if necessary.

As previously described, one of the problems with previous procurement systems is that a consignment order does not reference the blanket purchase agreement. This can lead to poor tracking and reconciliation of actual quantity ordered as compared to agreed purchase quantity on the blanket purchase agreement. Another problem is the problem of reconciliation between the receiving activities tracked on the consignment order and the billing activity for the consumption tracked against the consumption advice.

According to an embodiment, a consigned inventory procurement system can eliminate this problem of reconciliation and tracking across an entire consigned inventory procurement process. The consigned inventory procurement system can achieve reconciliation and tracking across a consigned inventory procurement process as follows. First, a consignment order generated by the consigned inventory procurement system can reference a blanket purchase agreement, so that the consignment order can access the blanket purchase agreement to receive consignment terms, purchasing terms, and pricing terms. This can provide the following capabilities. A blanket purchase agreement can be released at a point when the consignment order is generated rather than at a point of consumption. Ordered quantities can be tracked on the blanket purchase agreement for every consignment order issued against the blanket purchase agreement. A buyer can have full visibility of the consigned inventory procurement process, and can monitor a quantity of items ordered as compared to a previously-agreed upon purchase quantity. As a blanket purchase agreement reaches its usage limit, a buyer can proactively initiate a renegotiation and generate a new blanket purchase agreement before the previous blanket purchase agreements gets fully used or expires. Further, a reference between the consignment order and the blanket purchase agreement allows programmatic controls of the blanket purchase agreement to prevent over-ordering on consignment orders issued. As soon as a usage limit on a blanket purchase agreement is reached, the programmatic controls can prevent further consignment orders from being issued. This can give the buyer more complete control on the ordering process.

Further, a consumption advice generated by the consigned inventory procurement system can reference both the consignment order and the blanket purchase agreement. In combination with the consignment order referencing the blanket purchase agreement, this can provide complete traceability and transparency between ordering, receiving, and billing documents generated in the consigned inventory procurement process.

According to the embodiment, there can be complete transparency of receiving and billing activity between a blanket purchase agreement, a consignment order, and a consumption advice, as follows. As part of a consigned inventory procurement process, the consigned inventory procurement system can generate: (a) a blanket purchase agreement; (b) a consignment order that references the blanket purchase agreement; (c) a consigned inventory receipt (or receipt) that references the consignment order; (d) a consumption advice that references both the consignment order and the blanket purchase agreement; (e) an invoice that references the consumption advice; and (f) a payment that references the invoice. A blanket purchase agreement, a consignment order, a receipt, a consumption advice, an invoice, and a payment are all examples of documents, or other types of objects, that can be created by the consigned inventory procurement system, where an object is a logical entity that includes data. Thus, in accordance with the embodiment, when the consigned inventory procurement system generates a document or other type of object (such as a consignment order), the consigned inventory procurement system can automatically create the document or other type of object within the consigned inventory procurement system, where the document or other type of object includes the relevant data. Further, in accordance with the embodiment, when a first object references a second object, the first object can include an identifier that uniquely identifies the second object.

Thus, according to the embodiment, a buyer reviewing a blanket purchase agreement or a consignment order generated by the consigned inventory procurement system can effectively monitor a consigned inventory procurement process with up-to-date reporting on consignment orders issued, supplier shipments, shipments received and placed into consigned inventory, consumption of consigned items, consumption advices generated, and billing. No manual reconciliation is required, and the consigned inventory procurement system can eliminate reconciliation errors and costly efforts to correct such errors.

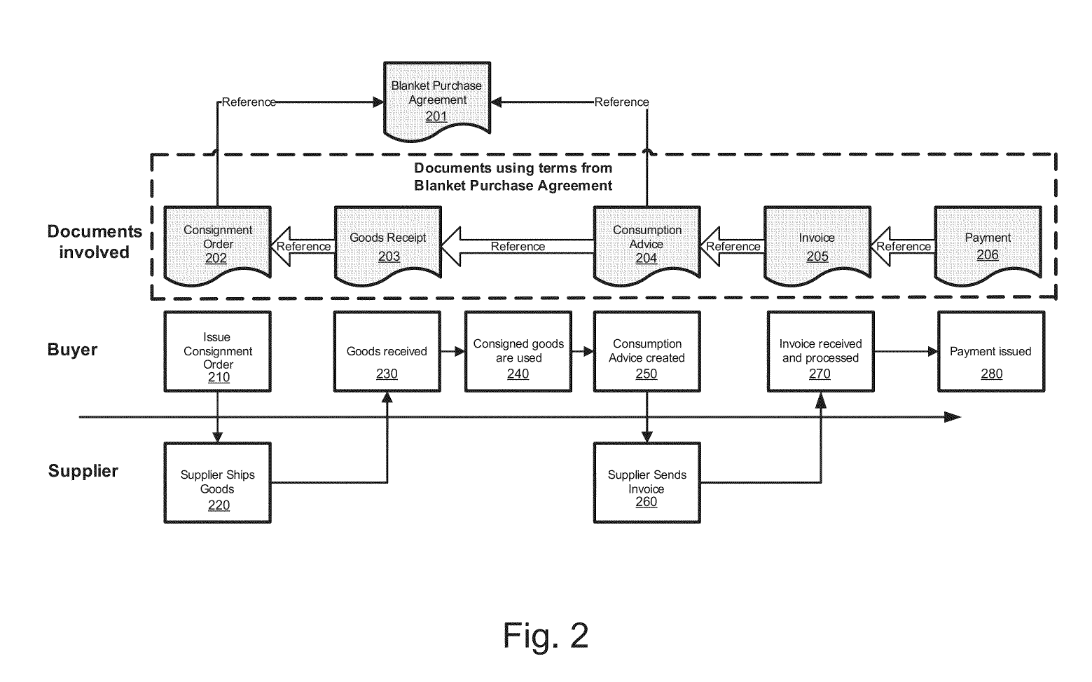

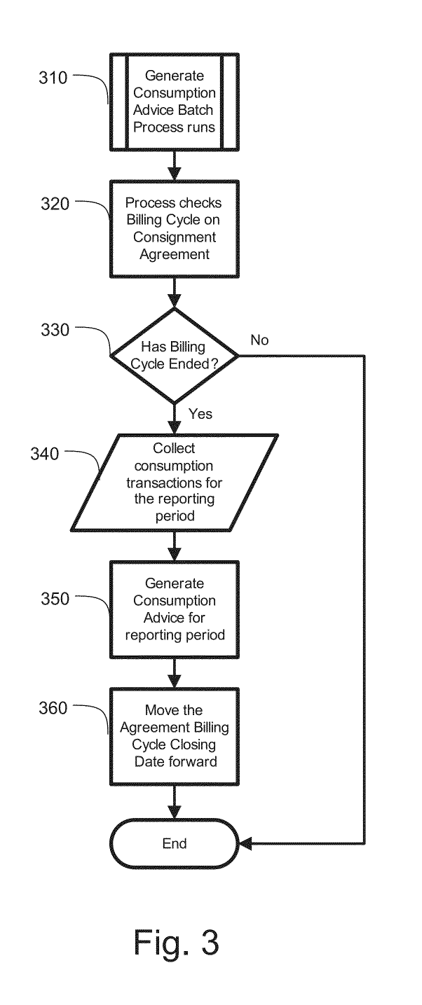

FIG. 2 illustrates a consigned inventory procurement process, according to an embodiment of the invention. In one embodiment, the functionality of the flow diagram of FIG. 2, as well as the functionality of the flow diagrams of FIGS. 3 and 5-6 below, are each implemented by software stored in a memory or some other computer-readable or tangible medium, and executed by a processor. In other embodiments, each functionality may be performed by hardware (e.g., through the use of an application specific integrated circuit (“ASIC”), a programmable gate array (“PGA”), a field programmable gate array (“FPGA”), etc.), or any combination of hardware and software. In certain embodiments, some of the functionality of the flow diagrams of FIGS. 2-3 and 5-6 can be omitted.

According to an embodiment, the consigned inventory procurement process can involve a buyer and a supplier, and can be executed by a consigned inventory procurement system. According to the embodiment, the consigned inventory procurement system first generates a blanket purchase agreement 201. Blanket purchase agreement 201 can include consignment terms, purchasing terms, and pricing terms. Examples of consignment terms include: an indication that consigned inventory items are purchased under a consignment arrangement, an aging period that specifies a period for which the consigned inventory items can be consigned before the consigned inventory items are considered purchased, a frequency for reporting consumption transactions via consumption advices, or a billing cycle for reporting consumption transactions via consumption advices, where the billing cycle includes a billing cycle opening date and a billing cycle closing date. An example of a purchasing term is a consigned inventory item quantity threshold. An example of a pricing term is a price for a consigned inventory item.

At 210, a buyer issues a consignment order to a supplier. A consignment order is an order for consigned inventory items, and identifies the consigned inventory items that are being purchased. In certain embodiments, the buyer issues a consignment order in response to a received requisition request for the consigned inventory items. In response to the buyer issuing the consignment order, the consigned inventory procurement system generates a consignment order 202, where consignment order 202 references blanket purchase agreement 201. In certain embodiments, consignment order 202 is generated in response to a requisition request for the consigned inventory items received from a purchasing system (not shown in FIG. 2).

At 220, a supplier ships the consigned inventory items (identified in FIG. 2 as “goods”) to the buyer. At 230, the buyer receives the consigned inventory items (identified in FIG. 2 as “goods”). In response to the buyer receiving the consigned inventory items, the consigned inventory procurement system generates a receipt 203 (identified in FIG. 2 as “goods receipt”), where receipt 203 references consignment order 202. A receipt (such as receipt 203) identifies that items, such as consigned inventory items, have been received.

At 240, one, some, or all, of the consigned inventory items (identified in FIG. 2 as “consigned goods”) are consumed, or otherwise used, by the buyer. At 250, in response to the consumption, or use, of the consigned inventory items, a consumption advice is created and sent to the supplier. A consumption advice identifies consumption transactions, which are consumptions or usages of consigned inventory items. A consumption advice can include a reporting period, where the reporting period includes a reporting opening date and a reporting closing end date. In embodiments where the consumption advice includes a reporting period, the consumption advice can only include consumption transactions from the reporting period (i.e., consumption transactions with a consumption date that is greater than or equal to the reporting opening date and less than or equal to the reporting closing date). In response to the consumption advice being created, the consigned inventory procurement system generates a consumption advice 204, where consumption advice 204 references both blanket purchase agreement 201 and receipt 203. Consumption advice 204 can include one or more consumption transactions. Consumption advice 204 can also include a reporting period, where the reporting period includes a reporting opening date and a reporting closing date. In embodiments where consumption advice 204 includes a reporting period, consumption advice 204 can only include consumption transactions from the reporting period.

At 260, the supplier sends an invoice for the consigned inventory items that are consumed, or otherwise used, by the buyer. An invoice identifies prices for the consigned inventory items that are consumed, or otherwise used, at the time of consumption or usage. At 270, the buyer receives and processes the invoice. In response to the receiving and processing of the invoice, the consigned inventory procurement system generates an invoice 205, where invoice 205 references consumption advice 204.

At 280, the buyer issues a payment for the consigned inventory items that are consumed, or otherwise used, by the buyer. A payment identifies payments that the buyer makes for the consigned inventory items that are consumed, or otherwise used, by the buyer. In response to the issuing of the payment, the consigned inventory procurement system generates a payment 206, where payment 206 references invoice 205.

As previously described, in previous procurement systems, a frequency at which consumption advices are sent to the supplier are typically dictated by how often a batch process that is configured to send consumption advices to the supplier is scheduled to run, rather than having any negotiated terms or conditions that dictate a desired consumption advice frequency. Thus, according to an embodiment, a consigned inventory procurement system (such as consigned inventory procurement system 10 of FIG. 1) can generate a consumption advice with its own lifecycle. More specifically, the consumption advice that is generated by the consigned inventory procurement system can define a reporting period, and can include consumption transactions from the reporting period only, as opposed to consumption transactions from other reporting periods. By utilizing the consumption advice, a supplier can identify a quantity of consigned inventory that was consumed, or otherwise used, during the reporting period. This can eliminate any ambiguity for the supplier in determining a reporting period for the consumption advice, and can enable quick settlement.

Further, according to an embodiment, the consigned inventory procurement system can provide a set of terms that govern a frequency and period of generating the consumption advice. More specifically, a blanket purchase agreement can include terms to specify a frequency and billing cycle for a reporting period. These terms can be used as follows. The consigned inventory procurement system can execute a batch process configured to generate consumption advices. When the batch process executes, the batch process can check the blanket purchase agreement to determine whether a current billing cycle has ended and whether consumption advices are required to be sent for the current reporting period. If the current billing cycle has ended, then the batch process can collect consumption transactions that have been created in that billing cycle, and can summarize the consumption transactions within the consumption advice. In addition, if there are any backdated consumption transactions from previous reporting periods that have been created within the consigned inventory procurement system in the current reporting period, the batch process can revise a previously created consumption advice and include the backdated consumption transaction in the revised consumption advice.

Additionally, once the batch process completes generating consumption advices for the current reporting period, the batch process can move a billing cycle closing date on the blanket purchase agreement forward to define a closing date of the next billing period. The billing cycle closing date can be moved forward based on an advice generation frequency specified on the blanket purchase agreement. For example, if the frequency is a daily frequency, the billing cycle closing date can be moved forward by one day. If the frequency is a weekly frequency, the billing cycle closing date can be moved forward by one week. If the frequency is a monthly frequency, the billing cycle closing date can be moved forward by one month. Thus, even if the batch process is scheduled to execute three times a day, for example, when the batch process executes and checks the blanket purchase agreement, the batch process can determine that the billing cycle for the next reporting period has not yet ended (since the billing cycle closing date has been moved forward to define the closing date of the next reporting period), and the batch process does not generate a consumption advice for the blanket purchase agreement. This can ensure that the supplier receives a consumption advice at a frequency defined by the negotiated blanket purchase agreement.

FIG. 3 illustrates a consumption advice generation process, according to an embodiment of the invention. The flow begins and proceeds to 310. At 310, a batch process configured to generate a consumption advice is executed. The flow then proceeds to 320.

At 320, the batch process checks a billing cycle stored within a blanket purchase agreement. The billing cycle can include a billing cycle opening date and a billing cycle closing date. The flow then proceeds to 330.

At 330, the batch process determines whether the billing cycle has ended. The batch process can determine whether the billing cycle has ended by determining whether an execution date of the batch process is greater than a billing cycle closing date. If the batch process determines that the billing cycle has ended, the flow proceeds to 340. If the batch process determines that the billing cycle has not ended, the flow ends.

At 340, the batch process collects consumption transactions for the reporting period. The batch process can only collect consumption transactions with a consumption date within the reporting period. The flow then proceeds to 350.

At 350, the batch process generates a consumption advice for the reporting period. The consumption advice can include the collected consumption transactions. The flow then proceeds to 360.

At 360, the batch process moves the billing cycle closing date forward. The batch process can move the billing cycle closing date forward by setting the billing cycle closing date to a subsequent date. Further, the batch process can also move the billing cycle opening date forward. The batch process can move the billing cycle opening date forward by setting the billing cycle opening date to a subsequent date as well. Further, the batch process can set the billing cycle opening date and the billing cycle closing date to subsequent dates based on a frequency of the blanket purchase agreement. Examples of a frequency can include a daily frequency, a weekly frequency, or a monthly frequency. The flow then ends.

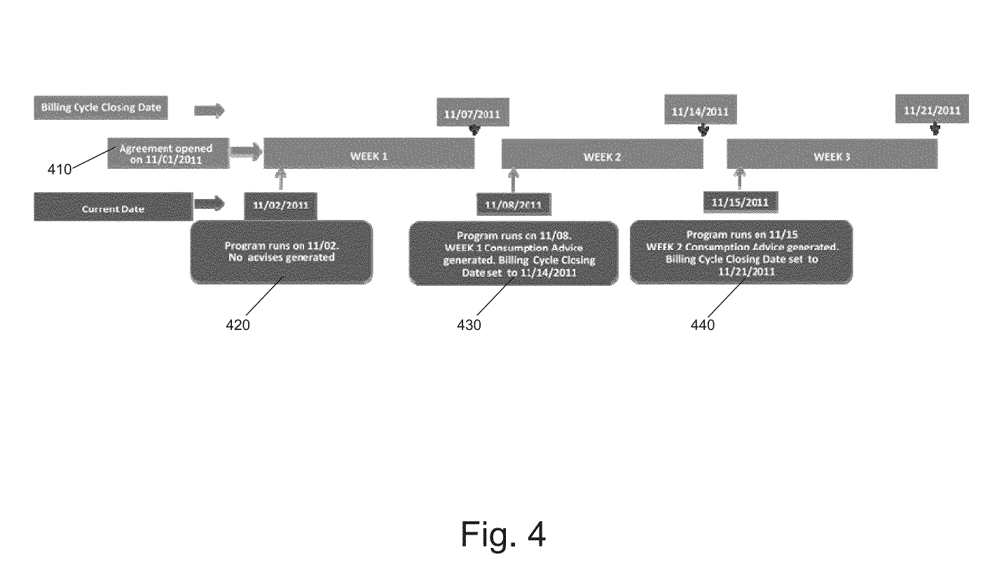

FIG. 4 illustrates an example sequence of events associated with a consumption advice generation process, according to an embodiment of the invention. At 410, a blanket purchase agreement is opened for execution on Nov. 1, 2011. The blanket purchase agreement includes a set of terms, where the set of terms includes a weekly frequency for generating consumption advices, and a billing cycle with a billing cycle closing date of Nov. 7, 2011. Further, a batch process configured to generate consumption advices is scheduled to execute once a day.

At 420, the batch process is executed on Nov. 2, 2011. The batch process checks the blanket purchase agreement. Since the billing cycle closing date is Nov. 7, 2011 and the execution date of the batch process is not greater than the billing cycle closing date, the batch process does not generate any consumption advices for consumption transactions associated with the blanket purchase agreement. Further, no consumption advices are generated for the batch process executions dated Nov. 3, 2011-Nov. 7, 2011.

At 430, the batch process is executed on Nov. 8, 2011. The batch process checks the blanket purchase agreement. Since the billing cycle closing date is Nov. 7, 2011, and the execution date of the batch process is greater than the billing cycle closing date, the batch process generates consumption advices for the consumption transactions associated with the blanket purchase agreement. The batch process then moves the billing cycle closing date forward to Nov. 14, 2011. Further, no consumption advices are generated for the batch process executions dated Nov. 9, 2011-Nov. 14, 2011.

At 440, the batch process is executed on Nov. 15, 2011. The batch process checks the blanket purchase agreement. Since the billing cycle closing date is Nov. 14, 2011, and the execution date of the batch process is greater than the billing cycle closing date, the batch process generates consumption advices for the consumption transactions associated with the blanket purchase agreement. The batch process then moves the billing cycle closing date forward to Nov. 21, 2011.

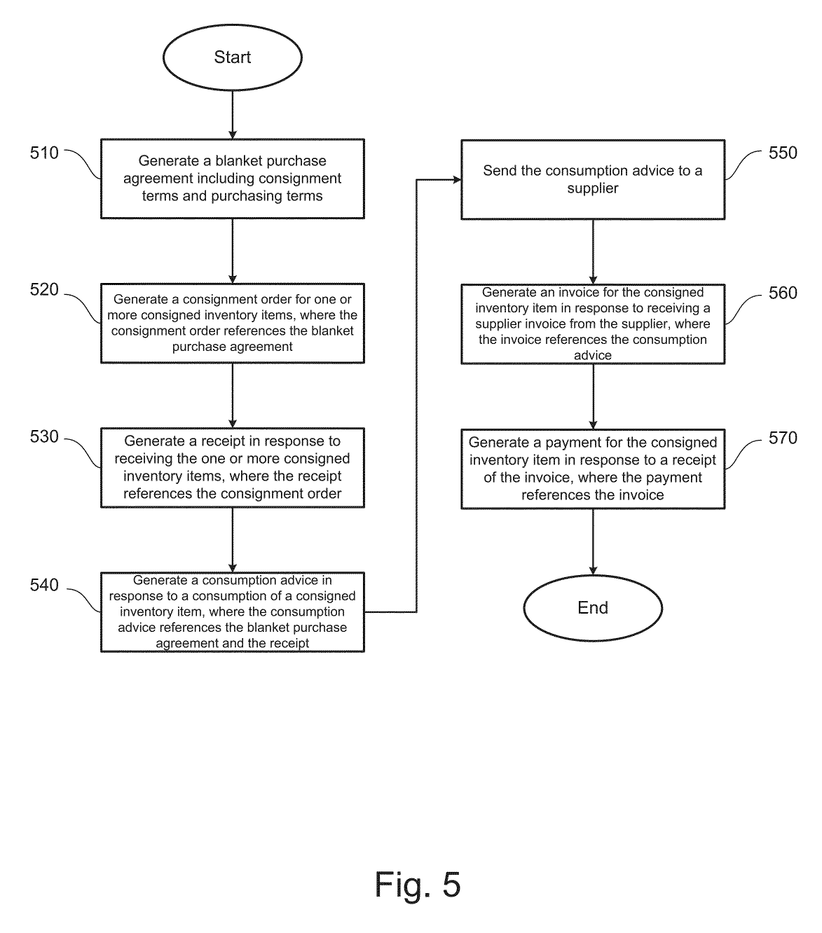

FIG. 5 illustrates a flow diagram of the functionality of a consigned inventory procurement module (such as consigned inventory procurement module 16 of FIG. 1), according to an embodiment of the invention. At 510, a blanket purchase agreement is generated, where the blanket purchase agreement includes one or more consignment terms and one or more purchasing terms. In certain embodiments, the one or more consignment terms can include at least one of: an indication that one or more consigned inventory items are purchased under a consignment arrangement; an aging period that specifies a period for which the one or more consigned inventory items can be consigned before the one or more consigned inventory items are considered purchased; or a frequency and a billing cycle comprising a billing cycle opening date and a billing cycle closing date. In other embodiments, the one or more purchasing terms can include a consigned inventory item quantity threshold. Further, in certain embodiments, the blanket purchase agreement can also include one or more pricing terms. In some of these embodiments, the one or more pricing terms can include one or more prices for the one or more consigned inventory items. The flow then proceeds to 520.

At 520, a consignment order is generated for one or more consigned inventory items, where the consignment order references the blanket purchase agreement. In certain embodiments, the consignment order can be generated in response to a requisition request for the one or more consigned inventory items received from a purchasing system. The flow then proceeds to 530.

At 530, a receipt is generated in response to receiving the one or more consigned inventory items, where the receipt references the consignment order. The flow then proceeds to 540.

At 540, a consumption advice is generated in response to a consumption of at least one consigned item, where the consumption advice references the blanket purchase agreement and the receipt. The flow then proceeds to 550.

At 550, the consumption advice is sent to a supplier. The flow then proceeds to 560.

At 560, an invoice is generated for the at least one consigned inventory item in response to receiving a supplier invoice from the supplier, where the invoice references the consumption advice. The flow then proceeds to 570.

At 570, a payment is generated for the at least one consigned inventory item in response to a receipt of the invoice, where the payment references the invoice. The flow then ends.

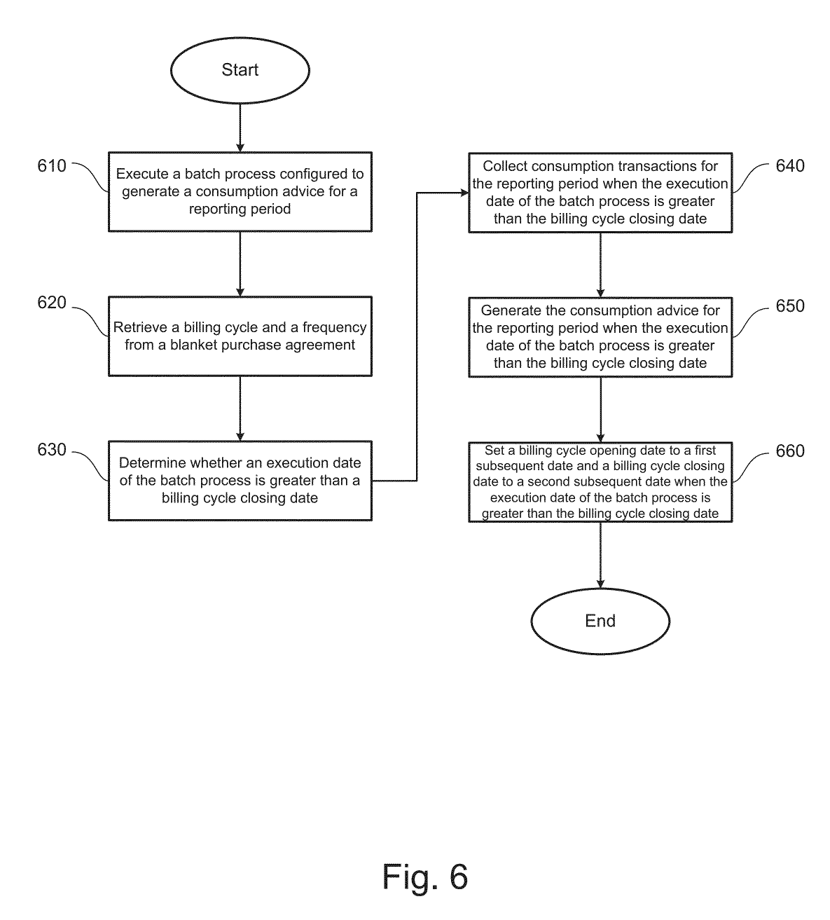

FIG. 6 illustrates a flow diagram of the functionality of a consigned inventory procurement module (such as consigned inventory procurement module 16 of FIG. 1), according to another embodiment of the invention. The flow begins and proceeds to 610. At 610, a batch process that is configured to generate a consumption advice for a reporting period is executed. The flow then proceeds to 620.

At 620, a billing cycle and a frequency are retrieved from a blanket purchase agreement using the batch process. In certain embodiments, the billing cycle can include a billing cycle opening date and a billing cycle closing date for a reporting period. Further, in some embodiments, a frequency can include one of: a daily frequency; a weekly frequency; or a monthly frequency. The flow then proceeds to 630.

At 630, it is determined whether an execution date of the batch process is greater than the billing cycle closing date using the batch process. The flow then proceeds to 640.

At 640, one or more consumption transactions for the reporting period are collected using the batch process when the execution date of the batch process is greater than the billing cycle closing date. The flow then proceeds to 650.

At 650, the consumption advice is generated for the reporting period using the batch process when the execution date of the batch process is greater than the billing cycle closing date, where the consumption advice includes the one or more consumption transactions. The flow then proceeds to 660.

At 660, the billing cycle opening date is set to a first subsequent date and the billing cycle closing date is set to a second subsequent date within the blanket purchase agreement using the batch process when the execution date of the batch process is greater than the billing cycle closing date. In certain embodiments, the billing cycle opening date can be set to the first subsequent date and the billing cycle closing date can be set to a second subsequent date based on the frequency. Further, in some embodiments, at least one consumption transaction for a previous reporting period that was entered in the reporting period can be collected using the batch process. In these embodiments, a previously created consumption advice can be revised to include the at least one consumption transaction using the batch process. The flow then ends.

Thus, a consigned inventory procurement system can provide effective control, management, and traceability of a consigned inventory procurement process. More specifically, the consigned inventory procurement system can provide a single source of truth for all consignment terms required for a consigned inventory procurement process by including the terms within a blanket purchase agreement. All the documents involved in the consigned inventory procurement process can use the terms on the blanket purchase agreement. Trading partners can use the blanket purchase agreement to craft a robust consignment relationship that has been negotiated and agreed upon, giving all parties visibility to the terms that govern the consigned inventory procurement process. In addition, the consigned inventory procurement system can also provide complete 360-degree traceability and transparency between ordering, receiving and billing documents involved in the consigned inventory procurement process. Both trading partners can have complete visibility into what is agreed, ordered, received, placed in consigned inventory, consumed, and billed. This can make it easy for procurement personnel to track and monitor the consigned inventory procurement process, and can prevent over-ordering and receiving/billing reconciliation errors.

Further, the consigned inventory procurement system can consolidate the required consignment terms with existing purchasing terms and pricing terms on the blanket purchase agreement. This can eliminate the need to setup and maintain an ASL entry for the purpose of establishing a consignment relationship between the trading partners. Thus, the consigned inventory procurement system can significantly reduce operational costs for customers with simple procurement processes who do not need the extensive functionality offered by ASL entries and sourcing rules. In the aforementioned example of a blanket purchase agreement with 1,000 line items, a customer does not need to invest approximately 83 hours of effort into setting up ASL entries and sourcing rules. Further, the ASL entries and sourcing rules do not need to be maintained on an ongoing basis. Because these savings are per blanket purchase agreement, and because customers typically have one blanket purchase agreement per supplier and several hundred suppliers, the potential savings are significant.

The features, structures, or characteristics of the invention described throughout this specification may be combined in any suitable manner in one or more embodiments. For example, the usage of “one embodiment,” “some embodiments,” “certain embodiment,” “certain embodiments,” or other similar language, throughout this specification refers to the fact that a particular feature, structure, or characteristic described in connection with the embodiment may be included in at least one embodiment of the present invention. Thus, appearances of the phrases “one embodiment,” “some embodiments,” “a certain embodiment,” “certain embodiments,” or other similar language, throughout this specification do not necessarily all refer to the same group of embodiments, and the described features, structures, or characteristics may be combined in any suitable manner in one or more embodiments.

One having ordinary skill in the art will readily understand that the invention as discussed above may be practiced with steps in a different order, and/or with elements in configurations which are different than those which are disclosed. Therefore, although the invention has been described based upon these preferred embodiments, it would be apparent to those of skill in the art that certain modifications, variations, and alternative constructions would be apparent, while remaining within the spirit and scope of the invention. In order to determine the metes and bounds of the invention, therefore, reference should be made to the appended claims.

1. A computer-readable medium having instructions stored thereon that, when executed by a processor, cause the processor to manage a consigned inventory procurement, the managing comprising:
generating a blanket purchase agreement comprising one or more consignment terms and one or more purchasing terms;
generating a consignment order for one or more consigned inventory items, wherein the consignment order references the blanket purchase agreement;
generating a receipt in response to receiving the one or more consigned inventory items, wherein the receipt references the consignment order;
generating a consumption advice in response to a consumption of at least one consigned inventory item, wherein the consumption advice references the blanket purchase agreement and the receipt.

2. The computer-readable medium of claim 1, the managing further comprising:
executing a batch process configured to generate the consumption advice for a reporting period;
retrieving a billing cycle comprising a billing cycle opening date and a billing cycle closing date for the reporting period and a frequency from the blanket purchase agreement using the batch process;
determining whether an execution date of the batch process is greater than the billing cycle closing date using the batch process;
collecting one or more consumption transactions for the reporting period using the batch process when the execution date of the batch process is greater than the billing cycle closing date;
generating the consumption advice for the reporting period using the batch process when the execution date of the batch process is greater than the billing cycle closing date, wherein the consumption advice comprises the one or more consumption transactions; and
setting the billing cycle opening date to a first subsequent date and the billing cycle closing date to a second subsequent date within the blanket purchase agreement using the batch process when the execution date of the batch process is greater than the billing cycle closing date.

3. The computer-readable medium of claim 2, the managing further comprising:
collecting at least one consumption transaction for a previous reporting period that was entered in the reporting period using the batch process; and
revising a previously created consumption advice to include the at least one consumption transaction using the batch process.

4. The computer-readable medium of claim 2, wherein the billing cycle opening date is set to the first subsequent date and the billing cycle closing date is set to the second subsequent date based on the frequency.

5. The computer-readable medium of claim 4, wherein the frequency comprises one of: a daily frequency; a weekly frequency; or a monthly frequency.

6. The computer-readable medium of claim 1, wherein the one or more consignment terms comprise at least one of: an indication that the one or more consigned inventory items are purchased under a consignment arrangement; an aging period that specifies a period for which the one or more consigned inventory items can be consigned before the one or more consigned inventory items are considered purchased; or a frequency and a billing cycle comprising a billing cycle opening date and a billing cycle closing date.

7. The computer-readable medium of claim 1, wherein the one or more purchasing terms comprises a consigned inventory item quantity threshold.

8. The computer-readable medium of claim 1, wherein the consignment order is generated in response to a requisition request for the one or more consigned inventory items received from a purchasing system.

9. The computer-readable medium of claim 1, wherein the blanket purchase agreement further comprises one or more pricing terms.

10. The computer-readable medium of claim 9, wherein the one or more pricing terms comprises one or more prices for the one or more consigned inventory items.

11. The computer-readable medium of claim 1,
wherein the generating the blanket purchase agreement further comprises automatically creating a blanket purchase agreement object within a system;
wherein the generating the consignment order further comprises automatically creating a consignment order object within the system;
wherein the generating the receipt further comprises automatically creating a receipt object within the system;
wherein the generating the consumption advice further comprises automatically creating a consumption advice object within the system.

12. A computer-implemented method for managing a consigned inventory procurement, the computer-implemented method comprising:
generating a blanket purchase agreement comprising one or more consignment terms and one or more purchasing terms;
generating a consignment order for one or more consigned inventory items, wherein the consignment order references the blanket purchase agreement;
generating a receipt in response to receiving the one or more consigned inventory items, wherein the receipt references the consignment order;
generating a consumption advice in response to a consumption of at least one consigned inventory item, wherein the consumption advice references the blanket purchase agreement and the receipt.

13. The computer-implemented method of claim 12, further comprising:
executing a batch process configured to generate the consumption advice for a reporting period;
retrieving a billing cycle comprising a billing cycle opening date and a billing cycle closing date for the reporting period and a frequency from the blanket purchase agreement using the batch process;
determining whether an execution date of the batch process is greater than the billing cycle closing date using the batch process;
collecting one or more consumption transactions for the reporting period using the batch process when the execution date of the batch process is greater than the billing cycle closing date;
generating the consumption advice for the reporting period using the batch process when the execution date of the batch process is greater than the billing cycle closing date, wherein the consumption advice comprises the one or more consumption transactions; and
setting the billing cycle opening date to a first subsequent date and the billing cycle closing date to a second subsequent date within the blanket purchase agreement using the batch process when the execution date of the batch process is greater than the billing cycle closing date.

14. The computer-implemented method of claim 13, comprising:
collecting at least one consumption transaction for a previous reporting period that was entered in the reporting period using the batch process; and
revising a previously created consumption advice to include the at least one consumption transaction using the batch process.

15. The computer-implemented method of claim 13, wherein the billing cycle opening date is set to the first subsequent date and the billing cycle closing date is set to the second subsequent date based on the frequency.

16. The computer-implemented method of claim 15, wherein the frequency comprises one of: a daily frequency; a weekly frequency; or a monthly frequency.

17. A system for managing a consigned inventory procurement, the system comprising:
an agreement generation module configured to generate a blanket purchase agreement comprising one or more consignment terms and one or more purchasing terms;
an order generation module configured to generate a consignment order for one or more consigned inventory items, wherein the consignment order references the blanket purchase agreement;
a receipt generation module configured to generate a receipt in response to receiving the one or more consigned inventory items, wherein the receipt references the consignment order;
a consumption advice generation module configured to generate a consumption advice in response to a consumption of at least one consigned inventory item, wherein the consumption advice references the blanket purchase agreement and the receipt.

18. The system of claim 17, further comprising:
a consumption advice batch process module configured to execute a batch process configured to generate the consumption advice for a reporting period;
wherein the consumption advice batch process module is further configured to retrieve a billing cycle comprising a billing cycle opening date and a billing cycle closing date for the reporting period and a frequency from the blanket purchase agreement using the batch process;
wherein the consumption advice batch process module is further configured to determine whether an execution date of the batch process is greater than the billing cycle closing date using the batch process;
wherein the consumption advice batch process module is further configured to collect one or more consumption transactions for the reporting period using the batch process when the execution date of the batch process is greater than the billing cycle closing date;
wherein the consumption advice batch process module is further configured to generate the consumption advice for the reporting period using the batch process when the execution date of the batch process is greater than the billing cycle closing date, wherein the consumption advice comprises the one or more consumption transactions; and
wherein the consumption advice batch process module is further configured to set the billing cycle opening date to a first subsequent date and the billing cycle closing date to a second subsequent date within the blanket purchase agreement using the batch process when the execution date of the batch process is greater than the billing cycle closing date.

19. The system of claim 18,
wherein the consumption advice batch process module is further configured to collect at least one consumption transaction for a previous reporting period that was entered in the reporting period using the batch process; and
wherein the consumption advice batch process module is further configured to revise a previously created consumption advice to include the at least one consumption transaction using the batch process.

20. The system of claim 18, wherein the consumption advice batch process module is further configured to set the billing cycle opening date to the first subsequent date and set the billing cycle closing date to the second subsequent date based on the frequency.

21. The computer-readable medium of claim 1, the managing further comprising:
sending the consumption advice to a supplier;
generating an invoice for the at least one consigned inventory item in response to receiving a supplier invoice from the supplier, wherein the invoice references the consumption advice; and
generating a payment for the at least one consigned inventory item in response to a receipt of the invoice, wherein the payment references the invoice.
